(19) United States
(12) Patent Application Publication
(10) Pub. No.: US 2018/0080853 A1
(43) Pub. Date: Mar. 22, 2018

(54) ADDITIVE LIFE CONSUMPTION MODEL FOR PREDICTING REMAINING TIME-TO-FAILURE OF MACHINES

(71) Applicant: Siemens Aktiengesellschaft, Munich (DE)

(72) Inventors: Chao Yuan, Plainsboro, NJ (US); Amit Chakraborty, East Windsor, NJ (US); Akshay Patwal, Orlando, NJ (US); Matthew Evans, Winter Park, FL (US)

(21) Appl. No.: 15/267,881

(22) Filed: Sep. 16, 2016

(51) Int. Cl. G01M 15/14; G06N 99/00

(52) U.S. Cl. CPC G01M 15/14; G06N 99/005

(57) ABSTRACT

A system for predicting time-to-failure of a machine includes one or more processors and a non-transitory, computer-readable storage medium in operable communication with the processors. The computer-readable storage medium contains one or more programming instructions that, when executed, cause the processors to receive or retrieve multivariate time series data observed a plurality of times, and infer a plurality of state variables from the multivariate time series data, each state variable describing an operating condition of the machine at a particular time. The instructions further cause the processor to compute an average life consumption rate by applying a life consumption rate model to the plurality of state variables and time-to-failure for the machine based on the average life consumption rate. The time-to-failure for the machine may then be reported to one or more users.

### TECHNICAL FIELD

The present application is related to systems, methods, and apparatuses for an additive life consumption model for predicting remaining time-to-failure of machines. The technology described herein may be generally applied, for example, to determine the time-to-failure for gas turbines or other complex machines.

### BACKGROUND

A proper maintenance strategy is crucial for operating an expensive machine. Traditional methods include corrective maintenance and planned maintenance. The first happens only after the machine fails. This can be very costly if the damage happens to be catastrophic. The second approach is scheduled based on manufacturer recommendation and appears to be smarter. However, it often occurs that when the scheduled maintenance happens, the machine is still in good shape. Performing maintenance in such cases can cause unnecessary cost and loss of revenue.

In recent years, condition-based maintenance has received more attention. It happens only when the failure of a machine is predicted to happen soon. Otherwise, the machine will be let run. The success of this approach can not only save cost, but also shed light on how to operate a machine such that it can produce the most profit before breakdown.

Many condition-based maintenance approaches make the following assumption: there exists a measurable quantity indicating the aging process of the machine. As time goes by, this aging indicator will monotonically increase or decrease. When this value hits certain threshold, the machine is likely to fail. This indicator can have physical meanings such as wear, corrosion, fracture or deformation and is often assumed to have an exponential form over time. Various methods have used neural networks, kernel machines combined with particle filters to predict (simulate) the progress of this indicator and when it might hit the alarming threshold. However, in many applications, there may not be such aging indicator available.

Another major set of approaches are based on survival analysis, particularly the Proportional Hazards Model (PHM). PHM assumes that the total time-to-failure follows a distribution such as Weibull distribution. However, the actual shape or a parameter of the distribution depends on some variables of the machine. This makes the PHM adaptive to individual machines. It is easy to predict the remaining time-to-failure based on the current time by just using the conditional probability of the above distribution. However, the past operation of the machine, a multivariate time series, is often only summarized in one single number, which can cause significant information loss.

Accordingly, it is desired to provide new techniques for predicting the remaining time-to-failure of a machine and other condition-based machine maintenance.

### SUMMARY

Embodiments of the present invention address and overcome one or more of the above shortcomings and drawbacks, by providing methods, systems, and apparatuses related to an additive life consumption model for predicting remaining time-to-failure of a machine. Briefly, the techniques described herein define a new concept of “life,” which is unobserved. By monitoring multivariate time series data generated by the machine over time, a life consumption rate is derived that is used, in turn, to determine the time-to-failure for the machine.

According to some embodiments of the present invention, a method for predicting time-to-failure of a machine includes receiving or retrieving, by a computing system operably coupled with the machine, multivariate time series data observed a plurality of times. The computer system infers state variables from the multivariate time series data, each state variable describing an operating condition of the machine at a particular time and computes an average life consumption rate by applying a life consumption rate model to state variables. The computer system next computes time-to-failure for the machine based on the average life consumption rate. Then, the computing system may report the time-to-failure for the machine to one or more users.

In some embodiments of the aforementioned method, the life consumption rate model is learned by receiving training multivariate time series data observed over a training time period and inferring a plurality of training state variables from the training multivariate time series data. Each training state variable describes a past operating condition over the training time period. These state variables may comprise discrete values that, together with the multivariate time series data, form a hidden Markov model. Alternatively, the state variables may be continuous values that, collectively with the multivariate time series data, form a Kalman filtering model. A constrained optimization problem is created which independently models life consumption of each of training state variables. In embodiments, where the state variables comprise continuous values, the constrained optimization problem may be modeled using a non-linear black box model (e.g., a neural network). Once created, the constrained optimization problem may be solved by the computing system using a suitable technique (e.g., gradient-based algorithm, interior point algorithm, least square algorithm, etc.) to yield the life consumption rate model.

According to another aspect of the present invention, a system for predicting time-to-failure of a machine includes one or more processors and a non-transitory, computer-readable storage medium in operable communication with the processor(s). The computer-readable storage medium contains one or more programming instructions that, when executed, cause the processor(s) to implement the methods discussed above as being performed by the aforementioned computing system.

According to other embodiments, a machine comprises one or more processors and a non-transitory, computer-readable storage medium in operable communication with the processor(s), and a display. The computer-readable storage medium contains one or more programming instructions that, when executed, cause the processor(s) to collect multivariate time series data at a plurality of times; infer a plurality of state variables from the multivariate time series data, each state variable describing an operating condition of the machine at a particular time; compute an average life consumption rate by applying a life consumption rate model to state variables; and compute time-to-failure for the machine based on the average life consumption rate. The display presents the time-to-failure for the machine to one or more users. The machine in these embodiments may be, for example, a gas-turbine or similar complex machine.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides a graphical representation of an additive life consumption model for predicting remaining time-to-failure of a machine, according to some embodiments;

FIG. 2 provides an overview of a process for predicting time-to-failure of a machine, according to some embodiments; and

FIG. 3 illustrates an example of a computing environment within which embodiments of the invention may be implemented.

### DETAILED DESCRIPTION

The following disclosure describes the present invention according to several embodiments directed at an additive life consumption model for predicting remaining time-to-failure of a machine. The techniques described herein define a new concept of “life,” which is unobserved. Life starts with a certain value such as 100 and is consumed gradually as the machine runs. When life is consumed completely or becomes zero, the machine breaks down. Additionally, as described in further detail below, the operating conditions of a machine are divided into different states. It is assumed that under different states, the life is consumed differently. In other words, different states have different life consumption rates. In cases of discrete states, quadratic programming is used to learn life consumption rate. In cases of continuous states, general constrained optimization methods are used to learn life consumption rate. The techniques described herein may be applied to gas turbines or other complex machinery.

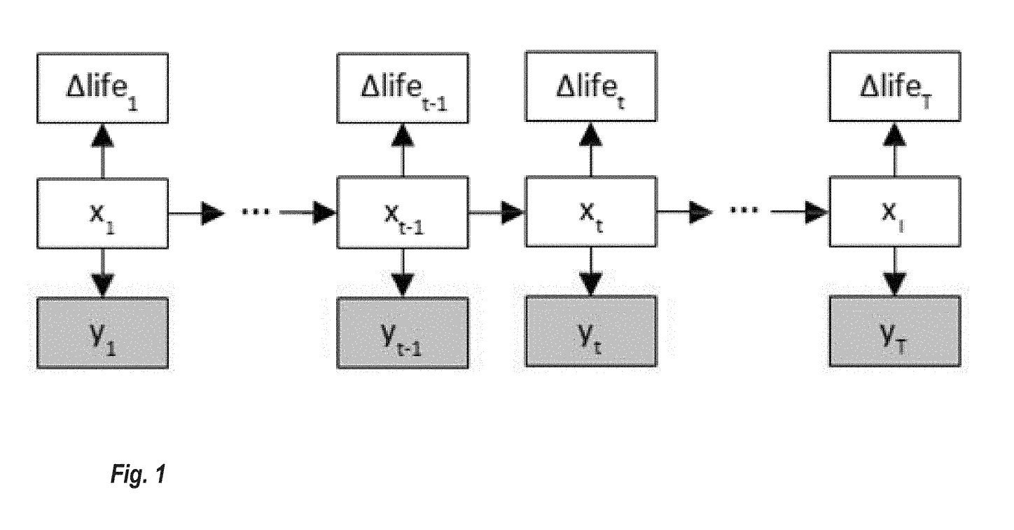

FIG. 1 provides a graphical representation of an additive life consumption model for predicting remaining time-to-failure of a machine, according to some embodiments. In this example, arrows indicate dependency of variables. The multivariate time series observed at time t is represented by yₜ. The time series yₜ can contain values from, for example, temperature, pressure or power. The observed variables are indicated by shaded nodes in FIG. 1.

Resolution of time t can be minute, hour, day, week or month, depending on applications. When t=1, the machine just starts a new cycle after the first installation or after a major inspection and maintenance; at that time, the machine can be assumed to be problem-free. When t=T, the machine breaks down and a maintenance must be carried out. T is the total time-to-failure. The goal is to predict the remaining time-to-failure, or T−t. Based on this prediction, the next maintenance event can be predicted.

Two hidden variables are introduced, denoted by white nodes in the model shown in FIG. 1. The first one xₜ is the state variable, which describes the operating condition of the machine. In some embodiments, xₜ is discrete and xₜ and yₜ form a hidden Markov model. In other embodiments, xₜ can be continuous and xₜ and yₜ form a Kalman filtering model. In either case, xₜ can be inferred from all past observed y_{1:t}=y₁y₂ . . . yₜ using standard techniques generally known in the art.

The second hidden variable Δlifeₜ denotes the life consumed at t. We assume that every machine gets a total life=100 to consume. In other words,

life=Δlife₁+Δlife₂+ . . . +Δlife_{T}=100. (1)

Note that the life defined here is different from life commonly used in terms like remaining useful life where life is same as time-to-failure. The model described herein is called “additive” because of the additive nature as shown in (1). It is sensible that under different operating conditions, a machine consume life differently. Therefore, a life consumption rate w is defined. The value of w depends on state x and can be viewed as a function over x. If w and x are known, the life consumed at that may be determined as follows:

Δlifeₜ=w(xₜ). (2)

To be able to use the model, the parameter of life consumption rate w is learned. Suppose that there are N time series, each representing a cycle of a machine. The n-th time series starts from 1 and ends at Tₙ (when the machine breaks). For time series n, the states x_{1:T}_{ₙ}⁽ⁿ⁾ are inferred from y_{1:T}_{ₙ}⁽ⁿ⁾ using dynamic Bayesian networks or similar techniques generally known in the art. Then, the corresponding life consumption equation may be determined based on (1) or (2). This may be repeated for all N time series to yield the following equations to solve:

$$\{ \begin{matrix}w ( {x}_{1}^{( 1 )} ) + w ( {x}_{2}^{( 1 )} ) + … + w ( {x}_{{T}_{1}}^{( 1 )} ) = 100 \\ w ( {x}_{1}^{( 2 )} ) + w ( {x}_{2}^{( 2 )} ) + … + w ( {x}_{{T}_{2}}^{( 2 )} ) = 100 \\ ⋮ \\ w ( {x}_{1}^{( N )} ) + w ( {x}_{2}^{( N )} ) + … + w ( {x}_{{T}_{N}}^{( N )} ) = 100 \\ w \geq 0\end{matrix} \qquad ( 3 )$$

The value of w is required to be nonnegative because life can only be consumed and not regained.

In the case of discrete states with at most K different possibilities, w can be represented by K numbers w₁, w₂ . . . w_{K}, or briefly as a column vector w=[w₁ w₂ . . . w_{K}]′. Then, (3) can be rewritten as:

$$\{ \begin{matrix}[ \begin{matrix}{\sum }_{t = 1}^{{T}_{1}} δ ( {x}_{t}^{( 1 )} - 1 ) & {\sum }_{t = 1}^{{T}_{1}} δ ( {x}_{t}^{( 1 )} - 2 ) & … & {\sum }_{t = 1}^{{T}_{1}} δ ( {x}_{t}^{( 1 )} - K ) \\ {\sum }_{t = 1}^{{T}_{2}} δ ( {x}_{t}^{( 2 )} - 1 ) & {\sum }_{t = 1}^{{T}_{2}} δ ( {x}_{t}^{( 2 )} - 2 ) & … & {\sum }_{t = 1}^{{T}_{2}} δ ( {x}_{t}^{( 2 )} - K ) \\ ⋮ & ⋮ & ⋱ & ⋮ \\ {\sum }_{t = 1}^{{T}_{N}} δ ( {x}_{t}^{( N )} - 2 ) & {\sum }_{t = 1}^{{T}_{N}} δ ( {x}_{t}^{( N )} - 2 ) & … & {\sum }_{t = 1}^{{T}_{N}} δ ( {x}_{t}^{( N )} - K )\end{matrix} ] W = [ \begin{matrix}100 \\ 100 \\ ⋮ \\ 100\end{matrix} ] . \\ w \geq 0\end{matrix} \qquad ( 4 )$$

δ(x) is 1 when x=0 or 0 everywhere else. Thus, Σₜ₌₁^{T}^{ₙ} δ(xₜ⁽ⁿ⁾−k) is the number of times state xₜ⁽ⁿ⁾ in the n-th time series is in the k-th state. Equation 4 may be solved, for example, by least square methods or, more generally, using quadratic programming.

In the case of continuous states, w_{θ}(x) can be modeled using nonlinear black box models such as, for example, neural networks with parameters θ. Equation (3) can be turned into a standard constrained optimization problem:

$$\{ \begin{matrix}{Min}_{θ} {\sum }_{n = 1}^{N} {( {\sum }_{t = 1}^{{T}_{n}} {w}_{θ} ( {x}_{t}^{( n )} ) - 100 )}^{2} \\ {w}_{θ} ( . ) \geq 0\end{matrix} \qquad ( 5 )$$

Equation (5) can be solved, for example, using a gradient-based algorithm such as the interior point algorithm.

Once the life consumption rate model w, an observed time series y_{1:t} from a test machine may be used to predict its remaining time-to-failure T−t. To do this, first y_{1:t} is estimated from x_{1:t} using Bayesian networks or other standard techniques generally known in the art. Then, the learned model is used to compute the life already consumed at time t as follows:

consumed life=w(x₁)+w(x₂)+ . . . +w(xₜ). (6)

The remaining life is simply:

remaining life=100−consumed life. (7)

Next, the past is generalized to forecast how the future life is going to be consumed. The average life consumption rate w̅ may be computed as follows:

$$\overline{w} = \frac{1}{t} ( w ( {x}_{1} ) + w ( {x}_{2} ) + … + w ( {x}_{1} ) ) . \qquad ( 8 )$$

The time-to-failure is how long it takes for the remaining life to be consumed using average life consumption rate:

$$T - t = \frac{remaining life}{\overline{w}} . \qquad ( 9 )$$

Note that sometimes the goal is not predicting time-to-failure, but remaining power or remaining equivalent baseload hours that the machine can produce before breakdown. This can be simply incorporated as follows. Suppose that the quantity we want to predict is z. The average production rate z/t may be computed from the past time series. Then, this may be extended to future to get the remaining z:

$$remaining z = \frac{z}{t} ( T - t ) . \qquad ( 10 )$$

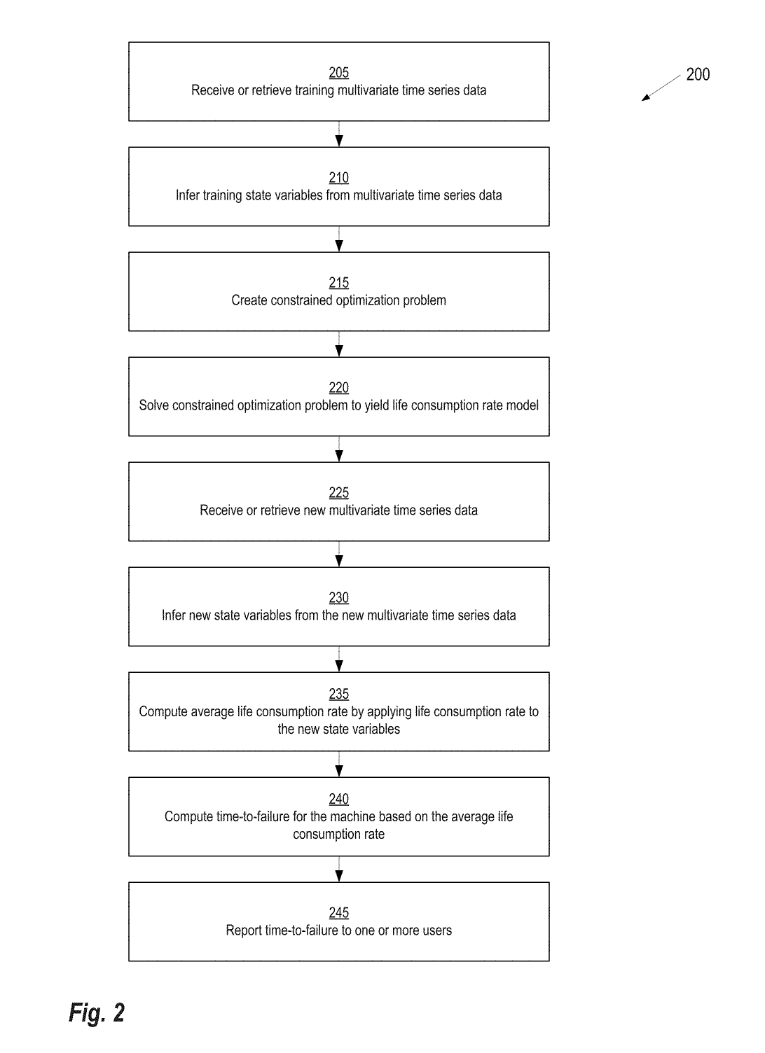

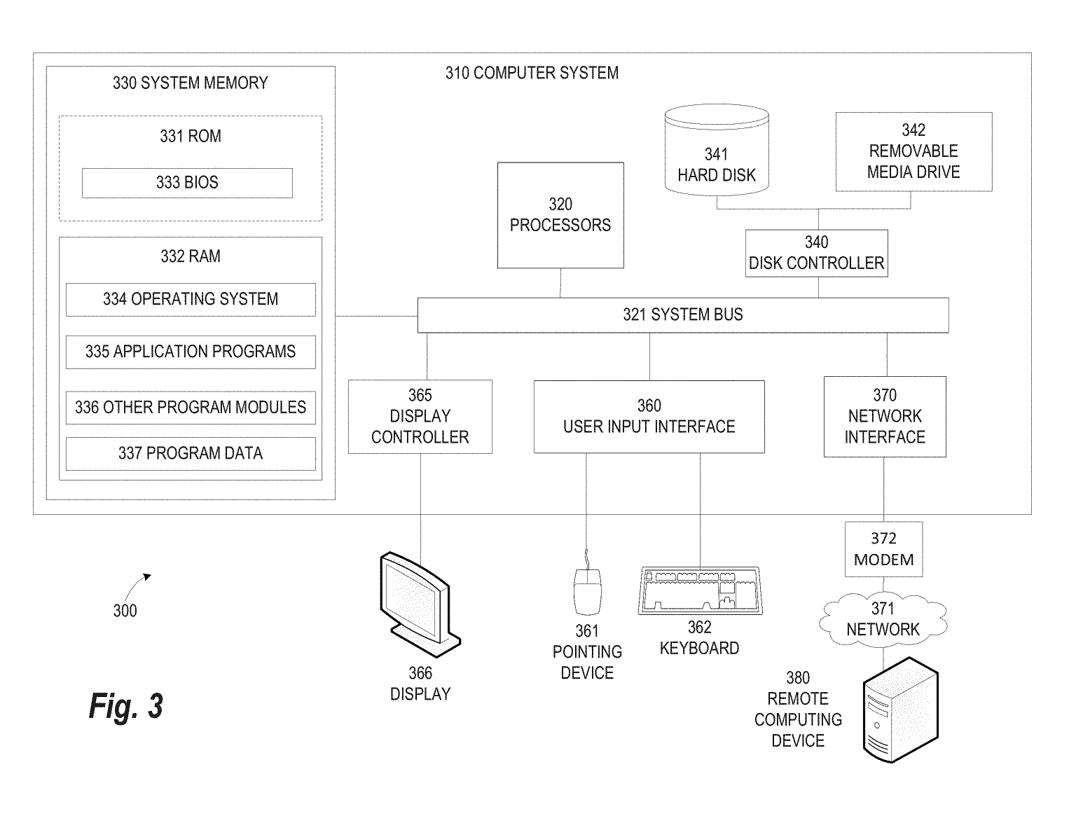

FIG. 2 provides an overview of a process 200 for predicting time-to-failure of a machine, according to some embodiments. This process 200 may be implemented, for example, using a specialized computing device comprising one or more processors and a non-transitory, computer-readable storage medium in operable communication with the processor. The computer-readable storage medium contains one or more programming instructions that, when executed, cause the processor to execute the process 200. In some embodiments, parallel computing environment (e.g., NVIDIA CUDA™ or similar platforms) may be used parallelize one or more of the computational steps of the process. An example computing environment on which the process 200 may be implemented is described below with reference to FIG. 3.

Starting at step 205, a training multivariate time series data is received or retrieved from a data source associated with the machine. In some instances, the data source may be included in the machine itself; while in other instances the database is remotely located (e.g., in a database of information from a particular production plant using the machine). The training multivariate time series includes data observed over a training time period. In general any time period may be selected, although there should be two considerations in selecting a suitable time period. First, the accuracy of the model is correlated with the amount of data used for training. Thus, as large a time period as practicable may be used. Secondly, depending on the type of data and the operations of the machine, certain data may be required to be sampled by a higher rate to capture all possible behaviors of the system.

Continuing with reference to FIG. 2, at step 210, training state variables are inferred from the training multivariate time series data. Each training state variable describes an operating condition of the machine at a particular time. Next, at step 215, a constrained optimization problem is created as described above with reference to Equation (3). As noted above in the discussion of Equation (3), this constrained optimization problem independently models life consumption of each of the training state variables. Then at step 220 the constrained optimization problem is solved (as described above) to yield the life consumption rate model.

Once training is complete, the life consumption rate model can be used to predict the remaining time-to-failure of the machine. Starting at step 225, new multivariate time series data is received or retrieved, either from machine directly or from a data source corresponding to the machine. In embodiments where the process 200 is implemented in the machine, the multivariate time series data may be collected directly by the machine itself based on periodic observations of the data being generated by the machine.

At step 230, a plurality of state variables are inferred from the multivariate time series data. As with the training data, each state variable inferred at step 230 describes an operating condition of the machine at a particular time. Next, at step 235, an average life consumption rate is computed by applying a life consumption rate model to the plurality of state variables. This step may apply Equations (6) and (7) to compute consumed life and remaining life, respectively. Then average life consumption rate may be computed according to Equation (8). It should be noted that these equations are exemplary and other equations may be used in different embodiments for computing the respective values. At step 240, time-to-failure for the machine is computed based on the average life consumption rate, for example, as set forth in Equation (9).

Once the time-to-failure value is determined, at step 245, it is reported to one or more users. For example, in some embodiments, all calculations are performed inside the machine and a display on the machine provides information detailing the time-to-failure. In other embodiments, a message may be sent to a user or the time-to-failure information can be recorded in a database for later use. In one embodiment, the aforementioned database is used to generate periodic alerts of machines with short time-to-failure. Alternatively (or additionally), the database can be used to generate reports for time-to-failure across an entire enterprise of machines. In this way, users can schedule down-time and budget for new machines according to the time-to-failure information.

FIG. 3 illustrates an example of a computing environment 300 within which embodiments of the invention may be implemented. Computing environment 300 may include computer system 310, which is one example of a computing system upon which embodiments of the invention may be implemented. For example, the process 200 shown in FIG. 2 may be implemented on such a computing environment 300. Computers and computing environments, such as computer system 310 and computing environment 300, are known to those of skill in the art and thus are described briefly here. Such a computing environment may be used to implement features associated with technology described herein such as, for example, the software and hardware components illustrated in FIG. 2.

As shown in FIG. 3, the computer system 310 may include a communication mechanism such as a bus 321 or other communication mechanism for communicating information within the computer system 310. The computer system 310 further includes one or more processors 320 coupled with the bus 321 for processing the information. The processors 320 may include one or more CPUs, GPUs, or any other processor known in the art.

The computer system 310 also includes a system memory 330 coupled to the bus 321 for storing information and instructions to be executed by processors 320. The system memory 330 may include computer readable storage media in the form of volatile and/or nonvolatile memory, such as read only memory (ROM) 331 and/or random access memory (RAM) 332. The system memory RAM 332 may include other dynamic storage device(s) (e.g., dynamic RAM, static RAM, and synchronous DRAM). The system memory ROM 331 may include other static storage device(s) (e.g., programmable ROM, erasable PROM, and electrically erasable PROM). In addition, the system memory 330 may be used for storing temporary variables or other intermediate information during the execution of instructions by the processors 320. A basic input/output system 333 (BIOS) containing the basic routines that help to transfer information between elements within computer system 310, such as during start-up, may be stored in ROM 331. RAM 332 may contain data and/or program modules that are immediately accessible to and/or presently being operated on by the processors 320. System memory 330 may additionally include, for example, operating system 334, application programs 335, other program modules 336 and program data 337.

The computer system 310 also includes a disk controller 340 coupled to the bus 321 to control one or more storage devices for storing information and instructions, such as a magnetic hard disk 341 and a removable media drive 342 (e.g., floppy disk drive, compact disc drive, tape drive, and/or solid state drive). The storage devices may be added to the computer system 310 using an appropriate device interface (e.g., a small computer system interface (SCSI), integrated device electronics (IDE), Universal Serial Bus (USB), or FireWire).

The computer system 310 may also include a display controller 365 coupled to the bus 321 to control a monitor or display 366, such as a cathode ray tube (CRT) or liquid crystal display (LCD), for displaying information to a computer user. The computer system includes an input interface 360 and one or more input devices, such as a keyboard 362 and a pointing device 361, for interacting with a computer user and providing information to the processor 320. The pointing device 361, for example, may be a mouse, a trackball, or a pointing stick for communicating direction information and command selections to the processor 320 and for controlling cursor movement on the display 366. The display 366 may provide a touch screen interface which allows input to supplement or replace the communication of direction information and command selections by the pointing device 361.

The computer system 310 may perform a portion or all of the processing steps of embodiments of the invention in response to the processors 320 executing one or more sequences of one or more instructions contained in a memory, such as the system memory 330. Such instructions may be read into the system memory 330 from another computer readable medium, such as a hard disk 341 or a removable media drive 342. The hard disk 341 may contain one or more datastores and data files used by embodiments of the present invention. Datastore contents and data files may be encrypted to improve security. The processors 320 may also be employed in a multi-processing arrangement to execute one or more sequences of instructions contained in system memory 330. In alternative embodiments, hard-wired circuitry may be used in place of or in combination with software instructions. Thus, embodiments are not limited to any specific combination of hardware circuitry and software.

As stated above, the computer system 310 may include at least one computer readable medium or memory for holding instructions programmed according to embodiments of the invention and for containing data structures, tables, records, or other data described herein. The term “computer readable medium” as used herein refers to any medium that participates in providing instructions to the processor 320 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 341 or removable media drive 342. Non-limiting examples of volatile media include dynamic memory, such as system memory 330. Non-limiting examples of transmission media include coaxial cables, copper wire, and fiber optics, including the wires that make up the bus 321. Transmission media may also take the form of acoustic or light waves, such as those generated during radio wave and infrared data communications.

The computing environment 300 may further include the computer system 310 operating in a networked environment using logical connections to one or more remote computers, such as remote computing device 380. Remote computing device 380 may be a personal computer (laptop or desktop), a mobile device, a server, a router, a network PC, a peer device or other common network node, and typically includes many or all of the elements described above relative to computer system 310. When used in a networking environment, computer system 310 may include modem 372 for establishing communications over a network 371, such as the Internet. Modem 372 may be connected to bus 321 via user network interface 370, or via another appropriate mechanism.

Network 371 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 310 and other computers (e.g., remote computing device 380). The network 371 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 371.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically, wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A system for predicting time-to-failure of a machine, the system comprising:
one or more processors; and
a non-transitory, computer-readable storage medium in operable communication with the processors, wherein the computer-readable storage medium contains one or more programming instructions that, when executed, cause the processors to:
receive or retrieving multivariate time series data observed a plurality of times;
infer a plurality of state variables from the multivariate time series data, each state variable describing an operating condition of the machine at a particular time;
compute an average life consumption rate by applying a life consumption rate model to the plurality of state variables;
compute time-to-failure for the machine based on the average life consumption rate; and
report the time-to-failure for the machine to one or more users.

2. The system of claim 1, wherein the one or more programming instructions additionally cause the processors to learn the life consumption rate model by:
receiving training multivariate time series data observed over a training time period;
inferring a plurality of training state variables from the training multivariate time series data, each training state variable describing a past operating condition over the training time period;
creating a constrained optimization problem which independently models life consumption of each of the plurality of training state variables;
solving the constrained optimization problem to yield the life consumption rate model.

3. The system of claim 2, wherein (a) the plurality of state variables comprise discrete values and (b) the multivariate time series data and the plurality of state variables form a hidden Markov model.

4. The system of claim 2, wherein (a) the plurality of state variables comprise continuous values and (b) the multivariate time series data and the plurality of state variables form a Kalman filtering model.

5. The system of claim 2, wherein the plurality of state variables are inferred using a dynamic Bayesian network.

6. The system of claim 2, wherein (a) the plurality of state variables comprises continuous values and (b) the constrained optimization problem is modeled using a non-linear black box model.

7. The system of claim 6, wherein the non-linear black box model is a neural network.

8. The system of claim 6, wherein the constrained optimization problem is solved using a gradient-based algorithm.

9. The system of claim 8, wherein the gradient-based algorithm is an interior point algorithm.

10. The system of claim 2, wherein the constrained optimization problem is solved using a least square method.

11. A method for predicting time-to-failure of a machine, the method comprising:
receiving or retrieving, by a computing system operably coupled with the machine, multivariate time series data observed a plurality of times;
inferring, by the computing system, a plurality of state variables from the multivariate time series data, each state variable describing an operating condition of the machine at a particular time;
computing, by the computing system, an average life consumption rate by applying a life consumption rate model to the plurality of state variables;
computing, by the computing system, time-to-failure for the machine based on the average life consumption rate; and
reporting, by the computing system, the time-to-failure for the machine to one or more users.

12. The method of claim 11, wherein the life consumption rate model is learned by:
receiving training multivariate time series data observed over a training time period;
inferring a plurality of training state variables from the training multivariate time series data, each training state variable describing a past operating condition over the training time period;
creating a constrained optimization problem which independently models life consumption of each of the plurality of training state variables;
solving the constrained optimization problem to yield the life consumption rate model.

13. The method of claim 12, wherein (a) the plurality of state variables comprise discrete values and (b) the multivariate time series data and the plurality of state variables form a hidden Markov model.

14. The method of claim 12, wherein (a) the plurality of state variables comprise continuous values and (b) the multivariate time series data and the plurality of state variables form a Kalman filtering model.

15. The method of claim 12, wherein the plurality of state variables are inferred using a dynamic Bayesian network.

16. The method of claim 12, wherein (a) the plurality of state variables comprises continuous values and (b) the constrained optimization problem is modeled using a non-linear black box model.

17. The method of claim 16, wherein the non-linear black box model is a neural network.

18. The method of claim 16, wherein the constrained optimization problem is solved using a gradient-based algorithm.

19. A machine, the machine comprising:
a processor; and
a non-transitory, computer-readable storage medium in operable communication with the processor, wherein the computer-readable storage medium contains one or more programming instructions that, when executed, cause the processor to:
collect multivariate time series data at a plurality of times;
infer a plurality of state variables from the multivariate time series data, each state variable describing an operating condition of the machine at a particular time;
compute an average life consumption rate by applying a life consumption rate model to the plurality of state variables;
compute time-to-failure for the machine based on the average life consumption rate; and
a display configured to present the time-to-failure for the machine to one or more users.

20. The machine of claim 19, wherein the machine is a gas-turbine.
